(19) United States
(12) Patent Application Publication
(10) Pub. No.: US 2024/0230242 A1
(43) Pub. Date: Jul. 11, 2024

(54) METHODS AND APPARATUSES FOR MAINTAINING SOLIDS AS A MELT

(71) Applicant: ExxonMobil Chemical Patents Inc., Baytown, TX (US)

(72) Inventors: Brian W. Heins, Humble, TX (US); Paul Hamilton, Hampshire (GB)

(21) Appl. No.: 18/561,649

(22) PCT Filed: May 12, 2022
(86) PCT No.: PCT/EP2022/062933

§ 371 Date: Nov. 16, 2023

Related U.S. Application Data
(60) Provisional application No. 63/194,462, filed on May 28, 2021.

(30) Foreign Application Priority Data
Jun. 30, 2021 (EP) 21182876.9

(51) Int. Cl. F28D 20/02; F28D 7/06; F28D 20/00

(52) U.S. Cl. CPC F28D 20/021; F28D 7/06; F28D 2020/0026; F28D 2020/0078

(57) ABSTRACT

Apparatuses for maintaining a solid as a melt (e.g., for storage or transport) may comprise: a closed vessel having an upper section and a lower section; a pool of a heat-receiving fluid located in the lower section; at least one product circulation conduit located in the lower section and at least partially immersed in the pool of the heat-receiving fluid; and a cooling fluid conduit located in the upper section and spaced apart from the pool of the heat-receiving fluid, the cooling fluid conduit being in thermal communication with vapor produced from the heat-receiving fluid; wherein a cooling fluid is present in the cooling fluid conduit.

### CROSS-REFERENCE TO RELATED APPLICATIONS

This application claims the priority benefit of U.S. Provisional Patent Application No. 63/194,462 filed on 28 May 2021 titled “Methods and Apparatuses for Maintaining Solids as a Melt” and EP Patent Application No. 21182876.9 filed on 30 Jun. 2021 titled “Methods and Apparatuses for Maintaining Solids as a Melt”, which are incorporated herein by reference in their entirety.

### FIELD

The present disclosure relates to apparatuses and processes for maintaining substances that are ordinarily solid at room temperature in a liquefied state.

### BACKGROUND

Growing demand in the cosmetic, pharmaceutical, home goods, and petroleum industries, among others, has driven the global market for compounds that are semi-solids at room temperature (e.g., waxes and similar compounds). Semi-solids are inclusive of compounds or mixtures that may exist as partially melted solids, solids in equilibrium with a liquid, and substances that may transition easily back and forth between a solid state and a liquid state at a low temperature. Semi-solids may exhibit a narrow melting point range, or melting may occur over a broad range, especially in the case of mixtures. Such semi-solid compounds may be referred to equivalently as low-melt compounds herein. Many types of semi-solid compounds and other substances or compounds having a low melting point are more conveniently handled and stored as a liquid. Although desirable, conventional equipment for storing and maintaining semi-solid compounds and similar substances in a liquefied state may have limitations, such as propensity toward forming solids during storage or during preparation for storage, particularly at a heat exchange interface. Solids formation may block flow pathways and cause various types of process disruptions, including decreasing the overall heat transfer coefficient due to the poorer thermal properties of the solid compared to the corresponding liquid.

Skin formation upon a liquefied solid is one problematic type of solids formation that may commonly occur during cooling. The term “skin” refers to a layer of solidified material on the surface of a liquid. Skin formation is sometimes referred to as “surface fouling.” Solids formation may also occur upon various surfaces in contact with a liquefied solid, such as at a heat exchanger surface, and solids formed upon the surface of a liquefied solid may also sink over time. Skin formation and other types of solids formation may be especially prevalent when a heat exchanger providing thermal regulation to a liquefied semi-solid or similar substance is maintained at a temperature significantly below the temperature of the liquefied semi-solid or similar substance. In addition to maintaining a liquefied semi-solid or similar substance at a desired storage temperature, heat exchangers may also be used, for example, when cooling a liquefied semi-solid or similar substance from a production temperature to a desired storage temperature above the melting point. Processes employing air cooling, tempered water cooling, chilled water cooling, or other low-temperature cooling means in direct thermal contact with a liquefied semi-solid or similar substance may be especially prone to skin formation or other production of solids due to a large temperature differential between the liquefied semi-solid or similar substance and the heat exchanger. Heated water or an alternate elevated-temperature cooling means within a heat exchanger in direct thermal contact with a liquefied semi-solid or similar substance may solve the problem of skin formation or other solids formation by decreasing the temperature differential, but lead to other issues such as problematic enthalpy dissipation from the heated water or alternate elevated-temperature cooling means and the need for heat exchangers having a large surface area due to the smaller temperature differential. Vaporization of the heat transfer fluid may also occur if the temperature of the liquefied semi-solid or similar substance is too high. Hence, there remains a need for cost-effective methods and apparatuses that may effectively maintain semi-solids or similar substances in a liquefied state and reduce or eliminate the risk of solids formation during storage.

### SUMMARY

In some aspects, the present disclosure provides apparatuses comprising: a closed vessel having an upper section and a lower section; a pool of a heat-receiving fluid located in the lower section; at least one product circulation conduit located in the lower section and at least partially immersed in the pool of the heat-receiving fluid; and a cooling fluid conduit located in the upper section and spaced apart from the pool of the heat-receiving fluid, the cooling fluid conduit being in thermal communication with vapor produced from the heat-receiving fluid; wherein a cooling fluid is present in the cooling fluid conduit.

In some or other aspects, the present disclosure provides apparatuses comprising: a closed vessel having an upper section and a lower section; wherein the lower section is configured to receive a pool of a heat-receiving fluid; at least one product circulation conduit located in the lower section and configured to be at least partially immersed in the pool of the heat-receiving fluid; and a cooling fluid conduit located in the upper section and configured to be spaced apart from the pool of the heat-receiving fluid, such that, when in use, the cooling fluid conduit is in thermal communication with vapor produced from the heat-receiving fluid; wherein a cooling fluid is present in the cooling fluid conduit.

In some or other aspects, the present disclosure provides systems comprising the foregoing apparatuses. The systems comprise: a facility forming or processing a liquefied solid having a temperature of about 40° C. or above, the liquefied solid being a solid or semi-solid material at room temperature; and an apparatus receiving the liquefied solid as a feed to the at least one product circulation conduit; wherein the heat-receiving fluid has a normal boiling point of about 50° c. or above.

In still other aspects, the present disclosure provides methods for processing a liquefied solid. The methods comprise: circulating a liquefied solid in at least one product circulation conduit that is at least partially immersed in a pool of a heat-receiving fluid located in a lower section of a closed vessel; wherein the heat-receiving fluid absorbs heat from the liquefied solid and a portion of the heat-receiving fluid forms vaporized heat-receiving fluid; circulating a cooling fluid through a cooling fluid conduit located in an upper section of the closed vessel, the cooling fluid conduit being spaced apart from the pool of the heat-receiving fluid; and condensing the vaporized heat-receiving fluid in the upper section, and returning a condensate to the lower section.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 is a diagram of a first configuration of an apparatus for maintaining a solid in a liquid state, in which a cooling fluid conduit and a product circulation conduit are oriented substantially horizontally.

FIG. 2 is a diagram of a second configuration of an apparatus for maintaining a solid in a liquid state, in which a cooling fluid conduit and a product circulation conduit are oriented substantially vertically.

FIG. 3 is a diagram of a third configuration of an apparatus for maintaining a solid in a liquid state, in which a cooling fluid conduit and a product circulation conduit are oriented both substantially horizontally and substantially vertically, and multiple product circulation conduits are present.

### DETAILED DESCRIPTION

The present disclosure relates to apparatuses and processes for storing and maintaining products that are ordinarily solids at room temperature (or another specified temperature) in a liquefied state at a higher temperature and, more particularly, apparatuses and processes that may lessen the likelihood of skin formation or other types of solids formation upon and/or within a liquefied solid during cooling thereof.

In conventional processes for maintaining a semi-solid or similar substance in a liquefied state during cooling, solids formation may become problematic. Direct contact of a heat exchanger utilizing air cooling, water cooling or other low-temperature heat exchange means with a liquefied solid may be especially prone to promoting skin formation or other types of solids formation due to a large temperature differential between the heat exchanger and the liquefied solid. Direct-contact heat exchangers containing heated water or other elevated-temperature cooling means may lessen the incidence of solids formation through decreasing the temperature differential between the heat exchanger and liquefied solid. However, this approach may result in problematic enthalpy dissipation and require large heat exchangers in order for effective process control to be realized. Vaporization and fouling of the heat transfer fluid may also occur in some instances.

Apparatuses and processes of the present disclosure may alleviate the foregoing difficulties by providing a pool of a heat-receiving fluid in direct contact with a conduit containing a liquefied solid, and a cooling fluid spaced apart from the pool of the heat-receiving fluid and the liquefied solid. In particular, the cooling fluid is located within a cooling fluid conduit that is in thermal contact with vapor produced from the heat-receiving fluid upon being heated by the liquefied solid. The cooling fluid is maintained at a temperature lower than the heat-receiving fluid, so that the cooling fluid may cool vapor liberated from the heat-receiving fluid. More particularly, in the apparatuses and processes of the present disclosure, the pool of the heat-receiving fluid is maintained in a closed vessel in direct contact with a product circulation conduit containing a liquefied solid to be maintained at a specified temperature, particularly wherein the product circulation conduit is at least partially immersed in the pool of the heat-receiving fluid. The specified temperature may be the freezing point of the liquefied solid at a minimum, but the specified temperature is preferably above the freezing point, such as about 5° C. or above, or about 10° C. or above, or about 15° C. or above, or about 20° C. or above, or about 25° C. or above. By maintaining the heat-receiving fluid in a closed vessel, loss of the heat-receiving fluid due to vaporization does not represent a significant concern. As the heat-receiving fluid absorbs heat from the liquefied solid and the liquefied solid cools, the pressure in the closed vessel increases as vapor is formed above the normal boiling point of the heat-receiving fluid (providing that the vessel is not being maintained at a sub-atmospheric state). Heat exchange of the vapor with the cooling fluid in the cooling fluid conduit returns a condensate to the pool of the heat-receiving fluid. Advantageously, the rate of condensation may be regulated by the cooling fluid flow rate and temperature within the cooling fluid conduit, thereby allowing the pressure and temperature within the closed vessel to be regulated by way of the cooling fluid to meet various application-specific needs. Alternately, the amount of heat-receiving fluid in the closed vessel may be altered to regulate the temperature within the closed vessel. Thus is, regulation of the cooling fluid (or the heat-receiving fluid) may modulate the pressure and, in turn, the boiling point of the heat-receiving fluid. By adjusting the boiling point of the heat-receiving fluid in the foregoing manner, the heat-receiving fluid may be regulated to provide a desired temperature for maintaining a liquefied solid in the product circulation conduit at the specified temperature, which is at or above the freezing point of the liquefied solid. The pressure in the closed vessel may vary from atmospheric pressure up to the maximum working pressure of the closed vessel, thereby allowing a wide range of temperatures to be provided from a single heat-receiving fluid. Thus, at or above atmospheric pressure, the normal boiling point represents the minimum temperature to which the heat-receiving fluid may cool the liquefied solid. Operation at a sub-atmospheric pressure is also possible as well, if one wishes to maintain the heat-receiving fluid at a temperature below the normal boiling point. Heat transfer may become more difficult as the vapor density decreases at lower pressures, although reduced pressure operations are still feasible in the disclosure herein.

Advantageously, the apparatuses and processes may feature a significant degree of self-regulation, since the operation depends largely upon the boiling point of the heat-receiving fluid and the pressure utilized to maintain the vessel at a desired temperature. As such, the apparatuses and processes of the present disclosure may lessen the need for equipment that may be otherwise used in maintaining a solid in a liquefied state, such as pumps, surge vessels, additional heat exchangers, control valves, and the like.

In some embodiments, the heat-receiving fluid may be an organic liquid, which may be selected based upon a desired temperature at which a liquefied solid is to be maintained. A suitable organic liquid may have a normal boiling point of at least the temperature at which the liquefied solid is to be maintained in the product circulation conduit. Assuming atmospheric pressure or above operation, the normal boiling point represents the minimum temperature at which the organic liquid may reliably maintain the liquefied solid in a liquid state. To provide a safety margin, the organic liquid may have a normal boiling point above the freezing point of the liquefied solid. Organic liquids are available with a wide range of boiling points, and a specific organic liquid may be chosen as a heat-receiving fluid in response to particular process needs or availability at a given process site. Mixtures of organic liquids may be used as well, provided that the mixture exhibits a suitably narrow boiling point range.

Depending on the temperature at which a liquefied solid is to be maintained, water may also be a suitable heat-receiving fluid. Water may offer advantages of low cost and minimal corrosion within the closed vessel.

Advantageously, tube bundle heat exchangers may be readily accommodated in the apparatuses and processes of the present disclosure. Unlike conventional heat exchange systems containing tube bundle heat exchangers, a liquefied solid may be maintained in at least one tube bundle to accomplish the features and benefits of the present disclosure. More specifically, a first tube bundle housing a liquefied solid may be immersed in the pool of the heat-receiving fluid to maintain the solid in a liquefied state. Vapor from the heat-receiving fluid may interact with a second tube bundle spaced apart from the pool of the heat-receiving fluid and containing a suitable cooling fluid, thereby maintaining the heat-receiving fluid at a desired temperature state by regulating pressure within the closed vessel. This configuration differs considerably from conventional shell-and-tube heat tube bundle heat exchangers, which typically circulated a substance to be cooled on the exterior of the tube bundles.

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature) is about 25° C.

As used in the present disclosure and claims, the singular article forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18.

As used herein, the term “hydrocarbon” refers to an organic compound or mixture of organic compounds that includes primarily, if not exclusively, the elements hydrogen and carbon. Optionally substituted hydrocarbons may also include other elements, such as, but not limited to, halogens, metallic elements, nitrogen, oxygen, sulfur, and any combination thereof. Unless otherwise specified, hydrocarbons may be one or more of linear, branched, cyclic, acyclic, saturated, unsaturated, aliphatic, or aromatic.

As used herein, the term “closed vessel” refers to a vessel that is not open to atmosphere during normal operation.

Embodiments of the present disclosure will now be described in further detail with reference to the drawings. With respect to the drawings, one having ordinary skill in the art will recognize other components that may be included for proper and safe operation of the apparatuses and processes depicted therein. Examples of components that may not be expressly depicted include, but are not limited to, flow meters, sensors, connections for filling and emptying fluids, safety devices, valves, pumps, and the like.

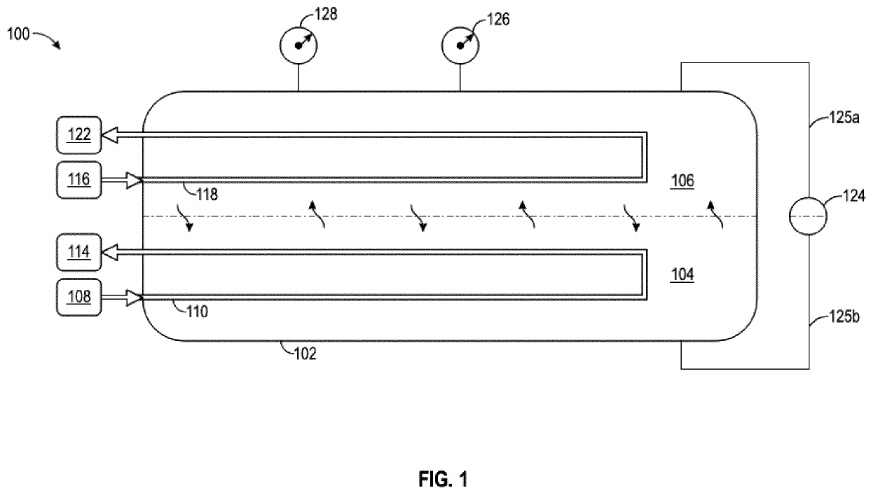

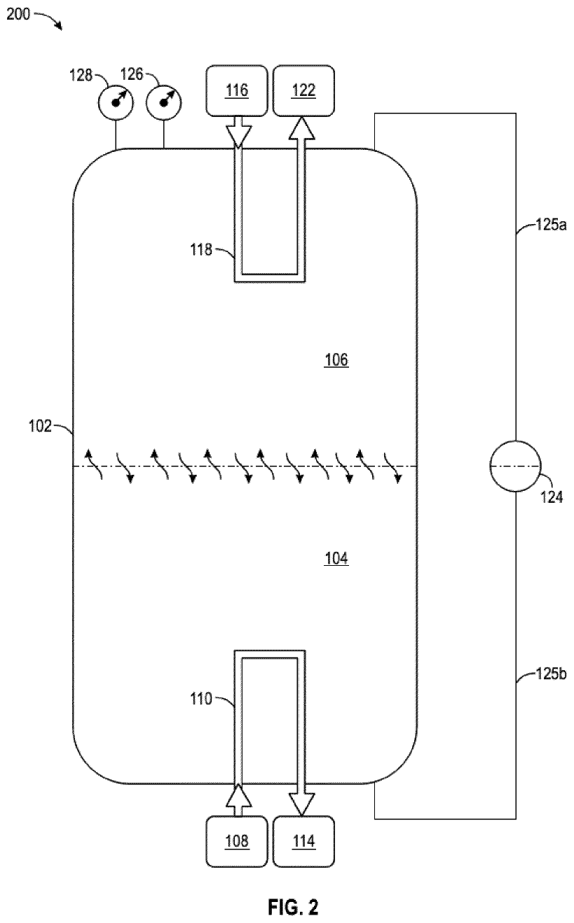

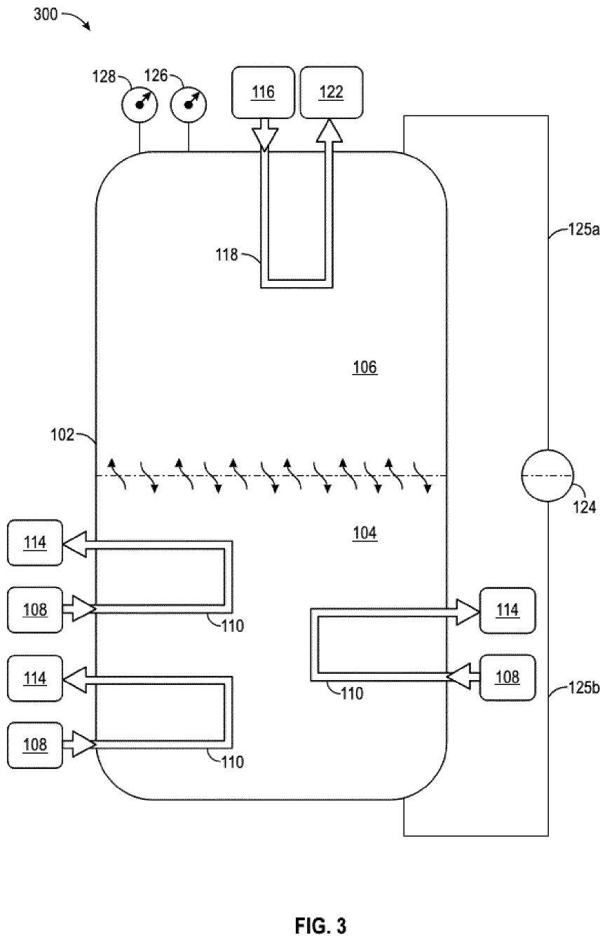

FIG. 1 is a diagram of a first configuration of an apparatus for maintaining a solid in a liquefied state. Apparatus 100 includes closed vessel 102 having lower section 104 and upper section 106. Lower section 104 is delineated by the level of a pool of a heat-receiving fluid housed therein, optionally an organic heat-receiving liquid, which at least partially immerses product circulation conduit 110. Although only one product circulation conduit 110 is depicted in FIG. 1, it is to be appreciated that more than one product circulation conduit 110 may be present (see FIG. 3). Any number of product circulation conduits 110 may be present, provided that they may be housed within closed vessel 110 and at least partially immersed in the pool of the heat-receiving fluid. In apparatus 100, product circulation conduit 110 enters closed vessel 102 through a sidewall thereof and is oriented substantially horizontally therein. A substantially vertical orientation for product circulation conduit 110 is also possible (see FIG. 2). Product circulation conduit 110 may comprise a tube bundle in particular examples of apparatus 100.

A liquefied solid enters product circulation conduit 110 via inlet port 108 and exits via outlet port 114. While within product circulation conduit 110, the liquefied solid undergoes heat exchange with the heat-receiving fluid in lower section 104 of closed vessel 102. As a result, the liquefied solid undergoes cooling, and the temperature of the heat-receiving fluid rises. Provided that the heat-receiving fluid is at or above the freezing point of the liquefied solid in product circulation conduit 110, the liquefied solid may remain in a liquid state. The temperature of the heat-receiving fluid may be modulated by regulating the pressure within closed vessel 102, as discussed herein.

As the heat-receiving fluid undergoes heat exchange with the liquefied solid in product circulation conduit 110, heating and vaporization may occur. Vapor from the heat-receiving fluid may enter upper section 106 and interact with cooling fluid conduit 118. Interaction of the vapor with cooling fluid conduit 118 forms a condensate that ultimately drains by gravity back into the pool of the heat-receiving fluid in lower section 104. Through controlling the rate of condensation by way of the cooling fluid in cooling fluid conduit 118, the pressure in closed vessel 102 may be regulated. Regulation of the pressure may, in turn, determine the boiling point of the heat-receiving fluid, and the temperature at which the heat-receiving fluid may maintain the liquefied solid in product circulation conduit 110. For example, if it is determined that the liquefied solid needs to be raised to a higher temperature, the pressure in closed vessel 102 may be allowed to rise to increase the boiling point of the heat-receiving fluid. Although shown in a substantially horizontal orientation in FIG. 1, like product circulation conduit 110, cooling fluid conduit 118 may likewise by oriented in a substantially vertical orientation in alternative apparatus configurations (see FIG. 2). Moreover, more than one cooling fluid conduit 118 may be present.

Even with vapor being formed, product circulation conduit 110 may remain fully or at least partially immersed (below) the liquid level in lower section 104. To ensure that product circulation conduit 110 remains fully or at least partially immersed and that no heat-receiving fluid has been lost, liquid level gauge 124 may be present. Equivalently, liquid level gauge 124 may be a sensor, instrument or like feature that provides autonomous readout. The liquid level observed in liquid level gauge 124 may be representative of the liquid level (and provide delineation between lower section 104 and upper section 106) within closed vessel 102. Since liquid level gauge 124 is in equilibrium with vapor via line 125a and with liquid via line 125b, the resulting liquid level in liquid level gauge 124 may be representative of that in closed vessel 102. Alternately, a window (not shown) may be located upon closed vessel 102 in order to monitor the liquid level therein. In addition to monitoring liquid level, temperature gauge 126 and pressure gauge 128 may be present to monitor these conditions inside closed vessel 102 as well. Temperature gauge 126 may comprise a thermocouple, and pressure gauge 128 may comprise a pressure transmitter, for example.

A suitable cooling fluid, preferably comprising water (e.g., heated water, ambient temperature water, or chilled water), is circulated through cooling fluid conduit 118, which is spaced apart from the pool of the heat-receiving fluid in lower section 104. Cooling fluid enters cooling fluid conduit 118 through inlet port 116 and exits through outlet port 122. Cooling fluid conduit 118 may comprise a tube bundle, which may be similar to that defining product circulation conduit 110. Suitable tube bundle configurations for performing heat exchange in a conventional manner will be familiar to persons having ordinary skill in the art.

Because the cooling fluid in cooling fluid conduit 118 is only in indirect thermal contact (via the vapor of the heat-receiving fluid) with the liquefied solid in product circulation conduit 110, there is no risk of the cooling fluid promoting skin formation or other types of solids upon the liquefied solid. The heat-receiving fluid may also be chosen such that it does not form solid upon the exterior of cooling fluid conduit 118, and instead simply forms a condensate that drains back into the pool of heat-receiving fluid within lower section 104. To avoid solid formation upon cooling fluid conduit 118, the heat-receiving fluid may be selected to have a melting point below the temperature at which the cooling fluid is circulated in cooling fluid conduit 118.

A substantially horizontal orientation for product circulation conduit 110 and cooling fluid conduit 118 may be advantageous, since tube bundles may be easily introduced and replaced in such orientations. Such a configuration is shown for apparatus 100 in FIG. 1. As referenced above, substantially vertical orientations for product circulation conduit 110 and cooling fluid conduit 118 are also possible, as shown for apparatus 200 in FIG. 2. Other than the substantially vertical orientation for product circulation conduit 110 and cooling fluid conduit 118, the configuration shown for apparatus 200 in FIG. 2 bears similarity to that shown for apparatus 100 in FIG. 1, and the detailed apparatus components will not be described again in detail in the interest of brevity.

Likewise, more than one product circulation conduit 110 and/or more than one cooling fluid conduit 118 may be present in the apparatuses described herein. Such a configuration is shown for apparatus 300 in FIG. 3, wherein multiple product circulation conduits 110 are present. Although not shown, multiple cooling fluid conduits 118 may be present in combination with multiple product circulation conduits 110 and/or multiple cooling fluid conduits 118 may be present in combination with a single product circulation conduit 110. Moreover, although FIG. 3 has depicted substantially horizontal orientations for multiple product circulation conduits 110 and a vertical orientation for cooling fluid circulation conduit 118, it is to be appreciated that any combination of substantially horizontal and substantially vertical orientations may be present. Particular configurations may be selected in response to application-specific needs, as well as configurations that maintain product circulation conduit(s) 110 at least partially immersed in the pool of the heat-receiving fluid and cooling fluid conduit(s) 118 spaced apart from the pool of the elevated-temperature heat-receiving fluid. When multiple product circulation conduits 110 are present, different liquefied solids may be present in at least some of them. In addition, product circulation conduit 110 and cooling fluid conduit 118 may be at least partially offset radially from one another.

When multiple product circulation conduits 110 are present, it may sometimes be desirable for the liquefied products in two or more of the product circulation conduits 110 to be maintained at different temperatures, specifically the temperature of the liquefied products as they exit their respective outlet ports 114. To control temperature independently within one or more product circulation conduits 110, a bypass line (not shown in FIG. 3) may extend from or proximal to inlet port 108 to or proximal to outlet port 114. A portion the liquefied product, instead of entering product circulation conduit 110, may instead combine with the stream exiting via outlet port 114. Thus, a first portion of the incoming liquefied product may undergo heat exchange with the heat-receiving fluid in lower section 104 and a second portion does not, thereby altering the temperature of the liquefied product exit at outlet port 114. The amount of liquefied product bypassing product circulation conduit 110 may allow the temperature to be independently regulated. Each product circulation conduit 110 may be controlled in this manner, if desired.

Accordingly, apparatuses of the present disclosure may comprise: a closed vessel having an upper section and a lower section; a pool of a heat-receiving fluid located in the lower section; at least one product circulation conduit located in the lower section and at least partially immersed in the pool of the heat-receiving fluid; and a cooling fluid conduit located in the upper section and spaced apart from the pool of the heat-receiving fluid, the cooling fluid conduit being in thermal communication with vapor produced from the heat-receiving fluid. A cooling fluid is present in the cooling fluid conduit.

In some apparatus configurations, the at least one product circulation conduit and/or the cooling fluid conduit may comprise a plurality of tube bundles, suitable configurations for which will be familiar to persons having ordinary skill in the art. The tube bundles may be similar to the “tube” portion of shell-and-tube heat exchanger configurations, which will be familiar to one having ordinary skill in the art. Thus, tube bundles lacking a shell may be incorporated in the disclosure herein to achieve better thermal contact when at least partially immersed in the pool of the heat-receiving fluid and/or when contacting a vapor derived from the heat-receiving fluid. U-shaped tube bundles may be incorporated as the at least one product circulation conduit and/or the cooling fluid conduit in any embodiment of the disclosure herein. Suitable tube bundles may feature an inlet port and an outlet port for conveying a suitable liquid therethrough.

The cooling fluid circulated through the cooling fluid conduit may comprise water, which is inclusive of tempered (heated or unheated water, including ambient temperature) water or chilled water. Temperatures for tempered water may range from about 10° C. to about 25° C., or about 20° C. to about 35° C., or about 20° C. to about 30° C., or about 20° C. to about 25° C., depending on ambient conditions and the source from which the water is being obtained. Depending on the temperature at which the liquefied solid is to be maintained, tempered water up to about 50° C. may also be suitable. The term “chilled water” refers to water, solutions of water and salt (including sea water), and solutions of water and water-miscible organic compounds, such as water-glycol solutions, that have been actively cooled in some manner. Chilled water may have a temperature from about 10° C. to about −15° C. or about 5° C. to about −15° C., depending on whether substantially pure water, water-salt or water-glycol solutions are being chilled and the starting temperature of the water prior to chilling. If even more extensive cooling of vapor arising from the heat-receiving fluid is needed, organic coolants may be employed in the cooling fluid conduit.

Particularly suitable heat-receiving fluids may have a normal boiling point of at least a temperature at which a liquefied solid is to be maintained in the at least one product circulation conduit, which may be at or above the freezing point of the liquefied solid. As the pressure in the closed vessel increases, the boiling point of the heat-receiving fluid exceeds the normal boiling point, thereby allowing the temperature at which the liquefied solid is maintained to be regulated by way of the pressure in the closed vessel. The pressure, in turn, may be regulated by the cooling fluid in the cooling fluid conduit. Namely, pressure within the closed vessel may be controlled by regulating the temperature and flow rate of the cooling fluid in the cooling fluid conduit. Thus, by maintaining the pressure of the closed vessel at a desired level in the presence of a particular heat-receiving fluid, a liquefied solid may be maintained at a specified temperature above the freezing point of the liquefied solid. By choosing a heat-receiving fluid having a normal boiling point that is at least equal to the temperature at which the liquefied solid is to be maintained, the normal boiling point establishes the lowest temperature at which the liquefied solid may be maintained, provided that a pressure in the closed vessel is atmospheric or above. Sub-atmospheric operation of the closed vessel is possible, however, in which case a heat-receiving fluid having a boiling point higher than the specified temperature of the liquefied solid may be chosen.

Alternately, a heat-receiving fluid having a normal boiling point below the temperature at which the liquefied solid is to be maintained may be chosen. In this situation, the vessel may be pressurized above atmospheric pressure to raise the boiling point sufficiently to maintain the liquefied solid at a desired temperature. The extent to which the pressure may be raised (and, hence, how much the normal boiling point may deviate from the temperature at which the liquefied solid is to be maintained) is determined by safe operating pressures for the closed vessel. Preferably, the pressure increase needed may be limited such that material upgrades for fabricating the vessel are not necessary (e.g., upgrading from a 150 lb flange rating to a 300 lb flange rating).

Preferably, the heat-receiving fluid may have a narrow boiling point range. A narrow boiling point range may provide optimal control for maintaining the solid in a liquefied state at a specified temperature. In a non-limiting example, the heat-receiving fluid may have an ASTM D86 range between the Initial Boiling point and the Dry Point of about 10° C. or less, more preferably about 5° C. or less.

The heat-receiving fluid may be sourced from a process also producing the liquefied solid, or the heat-receiving fluid may be sourced from a nearby process by way of a pipe or other conduit. Sourcing the heat-receiving fluid in this manner may desirably limit burdens of unloading and transferring the heat-receiving fluid.

In more particular examples, a system may comprise a facility forming or processing a liquefied solid, preferably at a temperature of about 50° C. or above or about 40° C. or above, that is a solid or semi-solid at room temperature; and an apparatus of the present disclosure that receives the liquefied solid as a feed to the at least one product circulation conduit, in which the heat-receiving fluid has a normal boiling point of about 50° C. or above or about 40° C. or above. Optionally, the heat-receiving fluid may be received from the facility processing the liquefied solid or a nearby facility.

Particular examples of heat-receiving fluid that may meet the above criteria for having a narrow boiling point range and providing a specified pressure when heated within the closed vessel may include, for example, an optionally substituted C₂-C₄₀ hydrocarbon, such as a C₂-C₄₀ alkane, a C₂-C₄₀ alkene, a C₂-C₄₀ alcohol, a C₂-C₄₀ ether, a C₂-C₄₀ ketone, and any combination thereof. Suitable examples may include linear alpha olefins (LAOs), linear alpha olefin oligomers, or hydrogenated reaction products derived therefrom, particularly paraffinic waxes formed from LAOs or LAO oligomers. Even more specific examples of suitable heat-receiving fluid may include, for example, methyl ethyl ketone, methyl isobutyl ketone 1-hexene, 1-octene, 1-decene, isopropylbenzene, cyclohexane, methyl cyclohexane, n-hexane, ethanol, 2-ethoxy-2-methylpropane, 1,4-epoxybuta-1,3-diene, and any combination thereof.

Linear alpha olefins (LAOs), which also may be referred to as linear alpha alkenes, linear terminal olefins, linear terminal alkenes, or normal alpha olefins, are a commercially valuable class of chemical compounds. LAOs may be synthesized by several different processes starting from low molecular weight feedstock materials. The primary route for synthesizing LAOs is via ethylene oligomerization, of which there are several synthetic variants that may be mediated using different Ziegler-type catalysts. Depending on the particular Ziegler-type catalyst and the synthetic conditions, ethylene oligomerization reactions may form a distributed range of homologous LAOs having an even number of carbon atoms (i.e., C₂ₙH₂ₙ, where n is a positive integer greater than or equal to 2), or a predominant LAO (e.g., 1-butene, 1-hexene, 1-octene, or 1-decene) may be produced in much higher amounts than the other LAOs. When a distributed range of homologous LAOs is formed, the LAO product distribution may follow a Shulz-Flory distribution, with the distribution being arranged about a central molecular weight. Such LAO syntheses may be referred to “non-specific,” “full-range” or “wide-range” LAO syntheses. LAO syntheses affording a predominant LAO (e.g., about 70% or more or about 90% or more of the LAOs in the product stream) may also form up to about 10 wt. % of other minor product LAOs and additional byproducts. Such LAO syntheses may be referred to “specific” or “on-purpose” LAO syntheses.

Depending on the desired temperature at which to maintain the liquefied solid, a LAO having a suitable boiling point may be obtained from a specific LAO synthesis or isolated from a non-specific LAO synthesis. The LAO may also be hydrogenated to produce the corresponding alkane having the same number of carbon atoms. LAOs, including both single LAOs and mixtures of LAOs, may be oligomerized, preferably dimerized to form the corresponding C₄ₙH₄ₙ oligomers, which may be optionally hydrogenated for use as a heat-receiving fluid.

Materials that may benefit from processing through the disclosure herein are not believed to be particularly limited. That is, any material that may benefit from being stored in a liquefied state may be utilized in the disclosure herein. Example materials may include, but are not limited to, products obtained from conventional Group 1 lube basestock dewaxing plants, Fisher-Tropsch units, ethylene oligomerization plants, full range LAO plants, polyethylene plants, hydrocrackers, or fluid catalytic crackers; phthalic anhydride, waxes; semi-linear alcohols having about 15 carbon atoms or greater; and the like.

Waxes are a diverse class of organic compounds that are lipophilic, malleable solids near ambient temperatures. They include higher alkanes, higher alkenes and lipids, typically with melting points above about 40° C. (104° F.) to about 105° C. (220° F.), melting to give low viscosity liquids. Waxes are insoluble in water but soluble in organic, nonpolar solvents. Natural waxes of different types are produced by plants and animals. Waxes commonly occur as products from crude oil refining and from petrochemical processes like LAO and GTL, for example.

Processes of the present disclosure may comprise: circulating a liquefied solid in at least one product circulation conduit that is at least partially immersed in a pool of a heat-receiving fluid located in a lower section of a closed vessel, in which the heat-receiving fluid absorbs heat from the liquefied solid and a portion of the heat-receiving fluid forms vaporized heat-receiving fluid; circulating a cooling fluid through a cooling fluid conduit located in an upper section of the closed vessel, in which the cooling fluid conduit is spaced apart from the pool of the heat-receiving fluid; and condensing the vaporized heat-receiving fluid in the upper section and returning a condensate to the lower section. In more particular examples, the liquefied solid may be maintained at about 50° C. or above, or about 60° C. or above, or about 70° C. or above in the at least one product circulation conduit. The temperature may be above the freezing point of the liquefied solid.

In some examples, the liquefied solid may be introduced to the at least one product circulation conduit at a first temperature and is then cooled to a second temperature while thermally interacting with the heat-receiving fluid. For example, the liquefied solid may be formed by a production facility at a first temperature and be received in the product circulation conduit. Once in the product circulation conduit, the liquefied solid may lose heat to the heat-receiving fluid and undergo cooling to no lower than the boiling point of the heat-receiving fluid under the pressure conditions present in the closed vessel. The temperature to which the liquefied solid is cooled may be regulated through adjustment of the cooling fluid and the pressure within the closed vessel, as described in greater detail hereinabove.

Embodiments disclosed herein include:

A. Apparatuses for maintaining a solid in a liquefied state. The apparatuses comprise: a closed vessel having an upper section and a lower section; a pool of a heat-receiving fluid located in the lower section; at least one product circulation conduit located in the lower section and at least partially immersed in the pool of the heat-receiving fluid; and a cooling fluid conduit located in the upper section and spaced apart from the pool of the heat-receiving fluid, the cooling fluid conduit being in thermal communication with vapor produced from the heat-receiving fluid; wherein a cooling fluid is present in the cooling fluid conduit.

B. Systems capable of maintaining a solid in a liquefied state. The systems comprise: a facility forming or processing a liquefied solid having a temperature of about 40° C. or above, the liquefied solid being a solid or semi-solid material at room temperature; and the apparatus of A receiving the liquefied solid as a feed to the at least one product circulation conduit; wherein the heat-receiving fluid has a normal boiling point of about 50° C. or above.

C. Processes for maintaining a solid in a liquefied state. The processes comprise: circulating a liquefied solid in at least one product circulation conduit that is at least partially immersed in a pool of a heat-receiving fluid located in a lower section of a closed vessel; wherein the heat-receiving fluid absorbs heat from the liquefied solid and a portion of the heat-receiving fluid forms vaporized heat-receiving fluid; circulating a cooling fluid through a cooling fluid conduit located in an upper section of the closed vessel, the cooling fluid conduit being spaced apart from the pool of the heat-receiving fluid; and condensing the vaporized heat-receiving fluid in the upper section, and returning a condensate to the lower section.

Embodiments A-C may have one or more of the following additional elements in any combination:

Element 1: wherein the at least one product circulation conduit and the cooling fluid conduit each comprise a plurality of tube bundles having an inlet port and an outlet port.

Element 2: wherein the cooling fluid comprises water.

Element 3: wherein the apparatus further comprises a liquid level gauge or sensor, a temperature gauge or sensor, a pressure gauge or sensor, or any combination thereof.

Element 4: wherein the heat-receiving fluid is an optionally substituted C₂-C₄₀ hydrocarbon.

Element 5: wherein the heat-receiving fluid is selected from the group consisting of methyl ethyl ketone, methyl isobutyl ketone, 1-hexene, 1-octene, 1-decene, isopropylbenzene, cyclohexane, methylcyclohexane, toluene, n-hexane, ethanol, 2-ethoxy-2-methylpropane, 1,4-epoxybuta-1,3-diene, and any combination thereof.

Element 6: wherein the heat-receiving fluid consists essentially of a single organic compound.

Element 7: wherein the heat-receiving fluid has an ASTM D86 range between initial boiling point and dry point of about 10° C. or less.

Element 8: wherein the at least one product circulation conduit and the cooling fluid conduit are both oriented substantially horizontally within the closed vessel.

Element 9: wherein the at least one product circulation conduit and the cooling fluid conduit are both oriented substantially vertically within the closed vessel.

Element 10: wherein the at least one product circulation conduit is oriented substantially horizontally and the cooling fluid conduit is oriented substantially vertically within the closed vessel, or the at least one product circulation conduit is oriented substantially vertically and the cooling fluid conduit is oriented substantially horizontally within the closed vessel.

Element 10: wherein the at least one product circulation conduit comprises two or more product circulation conduits in the lower section that are at least partially immersed in the pool of the heat-receiving fluid.

Element 11: wherein the cooling fluid conduit is a single cooling fluid conduit.

Element 12: wherein a flow rate of the cooling fluid through the cooling fluid conduit or an amount of the heat-receiving fluid in the closed vessel is adjusted to maintain a pressure in the closed vessel at a specified level.

Element 13: wherein the liquefied solid is introduced to the at least one product circulation conduit at a first temperature and is then cooled to a second temperature while thermally interacting with the heat-receiving fluid.

Element 14: wherein different liquefied solids are housed in at least some of the two or more product circulation conduits.

By way of non-limiting example, illustrative combinations applicable to A and B include, but are not limited to, 1 and 2; 1 and 3; 1, and 4 or 5; 1, 4 and 6; 1 and 6; 1, 5 and 6; 1 and 7; 1,4 and 7; 1, 5 and 7; 1, and 8, 9 or 10; 1 and 11; 2 and 3; 2 and 4; 2, 4 and 5; 2, 4 and 6; 2 and 7; 2, and 8, 9 or 10; 2 and 11; 3, 4 and 5; 3, 4 and 6; 3 and 7; 3, and 8, 9 or 10; 3 and 11; 4, 5, 6 or 7, and 8, 9, or 10; 4, 5, 6 or 7, and 11; and 8, 9 or 10, and 11. Illustrative combination applicable to B include any of the foregoing in further combination with 13 or 14.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An apparatus comprising:
a closed vessel having an upper section and a lower section;
a pool of a heat-receiving fluid located in the lower section;
at least one product circulation conduit located in the lower section and at least partially immersed in the pool of the heat-receiving fluid; and
a cooling fluid conduit located in the upper section and spaced apart from the pool of the heat-receiving fluid, the cooling fluid conduit being in thermal communication with vapor produced from the heat-receiving fluid;
wherein a cooling fluid is present in the cooling fluid conduit.

2. The apparatus of claim 1, wherein the at least one product circulation conduit and the cooling fluid conduit each comprise a plurality of tube bundles having an inlet port and an outlet port.

3. The apparatus of claim 1, wherein the cooling fluid comprises water.

4. The apparatus of claim 1, further comprising:
a liquid level gauge or sensor, a temperature gauge or sensor, a pressure gauge or sensor, or any combination thereof.

5. The apparatus of claim 1, wherein the heat-receiving fluid is an optionally substituted C₂-C₄₀ hydrocarbon.

6. The apparatus of claim 1, wherein the heat-receiving fluid is selected from the group consisting of methyl ethyl ketone, methyl isobutyl ketone, 1-hexene, 1-octene, 1-decene, isopropylbenzene, cyclohexane, methylcyclohexane, toluene, n-hexane, ethanol, 2-ethoxy-2-methylpropane, 1,4-epoxybuta-1,3-diene, and any combination thereof.

7. The apparatus of claim 1, wherein the heat-receiving fluid consists essentially of a single organic compound.

8. The apparatus of claim 1, wherein the heat-receiving fluid has an ASTM D86 range between initial boiling point and dry point of about 10° C. or less.

9. The apparatus of claim 1, wherein the at least one product circulation conduit and the cooling fluid conduit are both oriented substantially horizontally within the closed vessel.

10. The apparatus of claim 1, wherein the at least one product circulation conduit and the cooling fluid conduit are both oriented substantially vertically within the closed vessel.

11. The apparatus of claim 1, wherein the at least one product circulation conduit is oriented substantially horizontally and the cooling fluid conduit is oriented substantially vertically within the closed vessel, or the at least one product circulation conduit is oriented substantially vertically and the cooling fluid conduit is oriented substantially horizontally within the closed vessel.

12. The apparatus of claim 1, wherein the at least one product circulation conduit comprises two or more product circulation conduits in the lower section that are at least partially immersed in the pool of the heat-receiving fluid.

13. The apparatus of claim 1, wherein the cooling fluid conduit is a single cooling fluid conduit.

14. A system comprising:
a facility forming or processing a liquefied solid having a temperature of about 40° C. or above, the liquefied solid being a solid or semi-solid material at room temperature; and
the apparatus of claim 1 receiving the liquefied solid as a feed to the at least one product circulation conduit;
wherein the heat-receiving fluid has a normal boiling point of about 50° C. or above.

15. A process comprising:
circulating a liquefied solid in at least one product circulation conduit that is at least partially immersed in a pool of a heat-receiving fluid located in a lower section of a closed vessel;
wherein the heat-receiving fluid absorbs heat from the liquefied solid and a portion of the heat-receiving fluid forms vaporized heat-receiving fluid;
circulating a cooling fluid through a cooling fluid conduit located in an upper section of the closed vessel, the cooling fluid conduit being spaced apart from the pool of the heat-receiving fluid; and
condensing the vaporized heat-receiving fluid in the upper section, and returning a condensate to the lower section.

16. The process of claim 15, wherein a flow rate of the cooling fluid through the cooling fluid conduit or an amount of the heat-receiving fluid in the closed vessel is adjusted to maintain a pressure in the closed vessel at a specified level.

17. The process of claim 15, wherein the at least one product circulation conduit and the cooling fluid conduit each comprise a plurality of tube bundles having an inlet port and an outlet port.

18. The process of claim 15, wherein the cooling fluid comprises water.

19. The process of claim 15, wherein the heat-receiving fluid is an optionally substituted C₂-C₄₀ hydrocarbon.

20. The process of claim 15, wherein the heat-receiving fluid is selected from the group consisting of methyl ethyl ketone, methyl isobutyl ketone, 1-hexene, 1-octene, 1-decene, isopropylbenzene, cyclohexane, methylcyclohexane, toluene, n-hexane, ethanol, 2-ethoxy-2-methylpropane, 1,4-epoxybuta-1,3-diene, and any combination thereof.

21. The process of claim 15, wherein the heat-receiving fluid consists essentially of a single organic compound.

22. The process of claim 15, wherein the heat-receiving fluid has an ASTM D86 range between initial boiling point and dry point of about 10° C. or less.

23. The process of claim 15, wherein the liquefied solid is introduced to the at least one product circulation conduit at a first temperature and is then cooled to a second temperature while thermally interacting with the heat-receiving fluid.

24. The process of claim 15, wherein the at least one product circulation conduit and the cooling fluid conduit are both oriented substantially horizontally within the closed vessel.

25. The process of claim 15, wherein the at least one product circulation conduit and the cooling fluid conduit are both oriented substantially vertically within the closed vessel.

26. The process of claim 15, wherein the at least one product circulation conduit is oriented substantially horizontally and the cooling fluid conduit is oriented substantially vertically within the closed vessel, or the at least one product circulation conduit is oriented substantially vertically and the cooling fluid conduit is oriented substantially horizontally within the closed vessel.

27. The process of claim 15, wherein the at least one product circulation conduit comprises two or more product circulation conduits in the lower section that are at least partially immersed in the pool of the heat-receiving fluid.

28. The process of claim 27, wherein different liquefied solids are housed in at least some of the two or more product circulation conduits.
